(19) United States
(12) Patent Application Publication
(10) Pub. No.: US 2021/0159004 A1
(43) Pub. Date: May 27, 2021

(54) MAGNETIC ASSEMBLY

(71) Applicant: Genesis Robotics and Motion Technologies, LP, Wichita, KS (US)

(72) Inventors: James Brent Klassen, Surrey (CA); Nathan Armstrong, Rockyview County (CA); David LOKHORST, Victoria (CA)

(73) Assignee: Genesis Robotics and Motion Technologies, LP, Wichita, KS (US)

(21) Appl. No.: 17/047,696

(22) PCT Filed: Mar. 22, 2019
(86) PCT No.: PCT/IB2019/052352

§ 371 Date: Oct. 15, 2020

Related U.S. Application Data
(60) Provisional application No. 62/661,073, filed on Apr. 22, 2018.
(60) Provisional application No. 62/661,619, filed on Apr. 23, 2018.

(51) Int. Cl. H01F 7/02; B25J 9/00; B25J 9/04; B25J 9/10; B25J 9/12; B25J 17/00

(52) U.S. Cl. CPC H01F 7/0242; B25J 9/0009; B25J 17/00; B25J 9/104; B25J 9/126; B25J 9/046

(57) ABSTRACT

A magnetic biasing assembly comprising: an inner element comprising: a north polarised inner arc, and a south polarised inner arc disposed axially adjacent to the north polarised inner arc, and an outer element arranged to rotate relative to the inner element about an axis, the inner and outer elements being substantially concentric, the outer element comprising: a north polarised outer arc, and a south polarised outer arc disposed axially adjacent to the north polarised outer arc, wherein the inner and outer polarised arcs are arranged so as to have a stable equilibrium position and are arranged to exert a magnetic moment between the inner and outer elements in a direction towards the stable equilibrium position when the inner and outer elements are not in the stable equilibrium position.

### FIELD OF THE INVENTION

The present invention relates to a magnetic biasing assembly and a robotic arm. In particular the invention relates to a robotic arm comprising a magnetic biasing assembly, and a method of assembling the magnetic biasing assembly.

### BACKGROUND OF THE INVENTION

It is known to lift a payload using an arm pivotable at a joint, and to actuate the arm by way of an electric motor. However, this involves supplying an electrical current to the electric motor to resist the weight of the arm and any payload being carried by the arm, even in cases when the arm is stationary. Therefore, a have efficient way to actuate the arm is desirable.

### SUMMARY OF THE INVENTION

According to a first aspect of the invention, there is provided a magnetic biasing assembly comprising: an inner element comprising: a north polarised inner arc, and a south polarised inner arc disposed axially adjacent to the north polarised inner arc, and an outer element arranged to rotate relative to the inner element about an axis, the inner and outer elements being substantially concentric, the outer element comprising: a north polarised outer arc, and a south polarised outer arc disposed axially adjacent to the north polarised outer arc, wherein the inner and outer polarised arcs are arranged so as to have a stable equilibrium position and are arranged to exert a magnetic moment between the inner and outer elements in a direction towards the stable equilibrium position when the inner and outer elements are not in the stable equilibrium position.

With such an arrangement, there is provided a magnetic biasing assembly which can generate a torque by passive means, allowing a consistent moment to be provided with no external energy input required.

Further, since magnetism is a conservative force, any work done against the magnetic moment will be conserved as magnetic potential energy and can be recovered by movement in the opposite direction.

This assembly also allows the use of easily manufactured and less expensive magnets with uniform polarity, i.e. all parts of a magnet may have the same magnetic field strength and direction.

The inner element may further comprise: a second north polarised inner arc arranged to be substantially coplanar with the south polarised inner arc in a plane normal to the axis, and a second south polarised inner arc disposed axially adjacent to the second north polarised inner arc and substantially coplanar with the north polarised inner arc in a plane normal to the axis, and the outer element may further comprise: a second north polarised outer arc arranged to be substantially coplanar with the south polarised outer arc in a plane normal to the axis, and a second south polarised outer arc disposed axially adjacent to the second north polarised outer arc and substantially coplanar with the north polarised outer arc in a plane normal to the axis.

With such an arrangement, the magnetic biasing assembly may generate a torque which is consistent for a greater rotational angle.

The coplanar inner and outer polarised arcs may be separated by a gap having a higher magnetic reluctance than the arcs. This gap can reduce flux leakage between respective coplanar arcs and thereby increase the amount of torque generated by the biasing assembly.

The magnetic biasing assembly may further comprise a plurality of permanent magnets arranged to polarise the north polarised arc and the south polarised arc of each pair of axially adjacent arcs. With such an arrangement, the arcs can be made of non-magnetic material and the magnets can be inserted individually, which can improve ease of manufacture.

The plurality of magnets may be arranged between the north polarised arc and the south polarised arc of each pair of axially adjacent arcs. This means that readily available bar magnets or arcuate magnets can be placed between the polarised arcs, allowing a low profile biasing assembly to be made.

The inner and outer elements may each contain three or more bar magnets, preferably more than 10 bar magnets, and adjacent bar magnets may be separated by a central angle of less than 36° measured at the axis. By providing a high number of magnets, the inconsistency in the magnetic torque profile due to cogging can be reduced. Thereby, a more consistent magnetic torque profile can be obtained.

The polarised arcs can have the form of ridges which may be separated by recesses, the recesses containing the magnets. This arrangement can provide a flux path which gives a high magnetic torque while providing a biasing assembly having a low radial thickness. The recesses may be arcuate, following a substantially similar radius to the polarised arcs, and may be parallel to the arcs.

The recesses may be on the outer side of the respective elements. This can improve manufacturability as the grooves may be created using a material removal process, such as a lathe, and thereby easier manufacturing methods may be used, reducing the cost of the biasing assembly.

Each arc may have a central angle of at least 160° and the equilibrium position may be where the inner and outer arcs are coterminous. This arrangement can allow the magnetic biasing assembly to have a torque profile which more closely cancels a self-weight of an arm at a range of angles without any gearing being required, since the magnetic torque profile will have only one stable equilibrium.

The arcs may be connected via a web extending across the web having a thickness less than the thickness of the arcs. This web can provide increased structural stiffness to the biasing assembly.

The web can comprise at least one void. The void can further reduce the magnetic reluctance of the web and thereby increase the magnetic biasing torque generated.

The magnetic biasing assembly may further comprise a friction inducing element arranged to exert a frictional moment between the inner and outer element. By providing a friction inducing element, the biasing assembly may exert a greater force on a robotic arm when it is to be held stationary. This may reduce energy usage in particular when the arm is stationary and carrying a payload.

The magnetic biasing assembly may further comprise at least one electrical coil arranged to generate a magnetic field when an electric current travels through the coil, and the electric coil may allow adjustment of the strength of the magnetic moment. This can increase or decrease the strength of the magnetic moment as required in order to assist the robotic arm in balancing payloads.

According to a second aspect of the present invention, there is provided a magnetic biasing arrangement comprising two magnetic biasing assemblies according to the first aspect, wherein the magnetic biasing assemblies are arranged concentrically.

An air gap between the two magnetic biasing assemblies may be wider than the spacing between the inner and outer elements of each assembly. This may prevent the magnetic fields of the two assemblies from interacting with each other.

The magnetic biasing arrangement may have a central cavity within the inner element of an inner magnetic biasing assembly and one or electric motors may be placed within the cavity. Thereby, there may be provided a compact and complete biasing arrangement for moving a robotic arm.

According to a third aspect of the invention, there is provided a robotic arm comprising: a base; a first member connected to the base via a first joint and pivotable to the relative to the base; a second member connected to the first member via a second joint and pivotable relative to the first member; and the magnetic biasing assembly according to the first aspect of the invention, arranged to exert a torque on the second member about the second joint to move the second member relative to the first member, wherein the magnetic biasing assembly is connected to the base so that the torque exerted on the second member is opposed by the base directed.

With such an arrangement, the weight of the second member, and in particular the torque about the second joint due to the weight of the second member, can be opposed at the base and therefore the torque to be exerted on the first member may be less dependent on the position of the second member. Thereby, there is provided a more easily controlled robotic arm.

The magnetic biasing assembly may be arranged at the first joint. This can reduce the weight of the first member and thereby provide a robot which requires less energy input. The magnetic biasing assembly may be coupled to the second member via a pulley and cable system.

In some embodiments, there may be no gearbox arranged between the magnetic biasing assembly and the second member and the magnetic biasing assembly and the second member may be coupled with a 1:1 relationship.

According to a fourth aspect of the invention, there is provided a robot arm comprising: a base; a first member connected to the base via a first joint and pivotable relative to the base; a second member connected to the first member via a second joint and pivotable relative to the first member; and a magnetic biasing arrangement according to the second aspect; wherein a first of the magnetic biasing assemblies is arranged to impart a torque to the second member about the second joint to move the second member relative to the first member, the torque from the first magnetic biasing assembling being opposed by the base directly, and wherein a second of the magnetic biasing assemblies is arranged to impart a torque to the first member about the first joint to move the first member relative to the base, the torque from the second magnetic biasing assembly being opposed by the base directly.

With such an arrangement, there is provided a SCARA robot arm requiring low energy use due to the balancing of the arm by the magnetic arrangement.

According to a fifth aspect of the present invention there is provided a method of manufacturing a magnetic biasing assembly comprising the following steps in the following order: inserting a first plurality of magnets into a circumferential recess of a first annular member; arranging the first annular member concentrically within a second annular member; and inserting a second plurality of magnets into the circumferential recess.

With such a method, there is provided a way to manufacture a magnetic biasing assembly, where concentric annular members having magnetic properties may be concentrically aligned without the alignment being made more difficult by substantial magnetic forces acting between the annular members.

The circumferential recesses may be formed using a material removal process, for example by using a material removal machine such as a lathe. The use of such a process provides a simple and low cost manufacturing method and thereby may reduce the overall complexity of manufacture.

The first annular member may be formed from an annular preform having a constant cross section. Since preforms having constant cross sections may be easily formed, such as by extrusion, this can provide a more simple manufacturing method.

The second annular member may further comprise an axial channel on an outer surface, and the second plurality of magnets may be inserted via the channel. By providing an axial channel and inserting the magnets via the channel, the insertion of the magnets after the concentric arrangement of the first and second annular members may be done more easily.

A magnetic biasing assembly according to the first aspect may be manufactured by a method according to the fifth aspect.

### BRIEF DESCRIPTION OF THE DRAWINGS

Various aspects of the present invention will now be described, by way of example only, with reference to the accompanying drawings, in which:

FIG. 1 shows a perspective view of a robot arm according to the invention;

FIG. 2 shows a perspective view of a robot arm according to the invention with a cover removed;

FIG. 3 shows a cross section of half of a magnetic biasing assembly according to the invention;

FIG. 4 shows an element of a magnetic biasing assembly according to the invention;

FIG. 5 shows a cross section of a magnetic biasing assembly installed within a base of a robotic arm according to the invention;

FIG. 6 shows a cross section of a robotic arm according to the invention; and

FIG. 7 shows a torque profile of a magnetic biasing assembly according to the invention.

### DETAILED DESCRIPTION

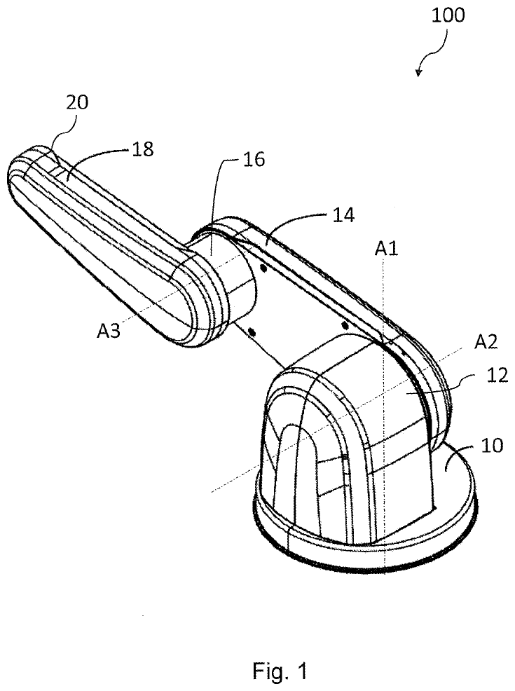

FIG. 1 shows an exterior perspective view of a robotic arm 100. The robotic arm 100 has a base 10, which may be stationary or may be rotatable about a vertical axis A1. The base 10 supports a first joint 12, which may also be referred to as a shoulder joint, and the first joint 12 supports a first member 14, which may also be referred to as an upper arm or bicep. The first joint 12 is at a first end of the first member 14, and at a second end of the first member 14, opposite the first end, there is a second joint 16, the second joint 16 may also be referred to as an elbow joint. The first member 14 may be pivotable relative to the base at the first joint 12 about a horizontal axis A2 extending through the first joint 12. At the second joint 16, there is a second member 18, which may be referred to as a forearm or a lower arm, which may be pivotable relative to the first member 14 about a horizontal axis A3 extending through the second joint 16. The second joint 16 may be at a first end of the second member 18, and there may be a third joint 20 at an opposite end of the second member 18.

The third joint 20 may be a wrist joint and may contain a rotational actuator. An end effector (not shown) may be connected to the second member 18 at the third joint 20.

Due to the first joint 12, second joint 16, and the rotatability of the base 10 about the vertical axis A1, the third joint 20 may be moveable in 3 degrees of freedom, or more, by the robotic arm 100.

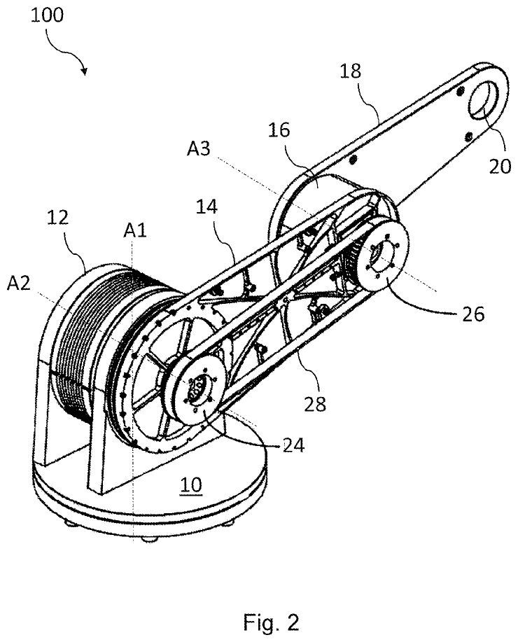

Each of the joints or members may contain inner elements such as pulleys, belts and/or cables, which are protected by exterior covers. FIG. 2 shows the robotic arm of FIG. 1, with a cover over the first member 14 removed, so that part of the inner mechanism of the robotic arm 100 can be seen.

In FIG. 2, it can be seen that there is a first pulley 24 situated at the first joint 12 and a second pulley 26 situated at the second joint 16, the pulleys being connected by a belt 28, which may be a toothed belt. The first pulley 24 is coupled to an actuator and/or a magnetic biasing assembly within the first joint 12 and the second pulley 26 is coupled to the second member 18. By this arrangement, the torque about the second joint 16 due to the weight of the second member 18 and/or any payloads or end effectors situated at the third joint 20 can be balanced by magnetic biasing assemblies and/or actuators within the first joint 12 and therefore only a minimal moment, or no moment, may be applied to the first member 14 by the second member 18 at the second joint 16.

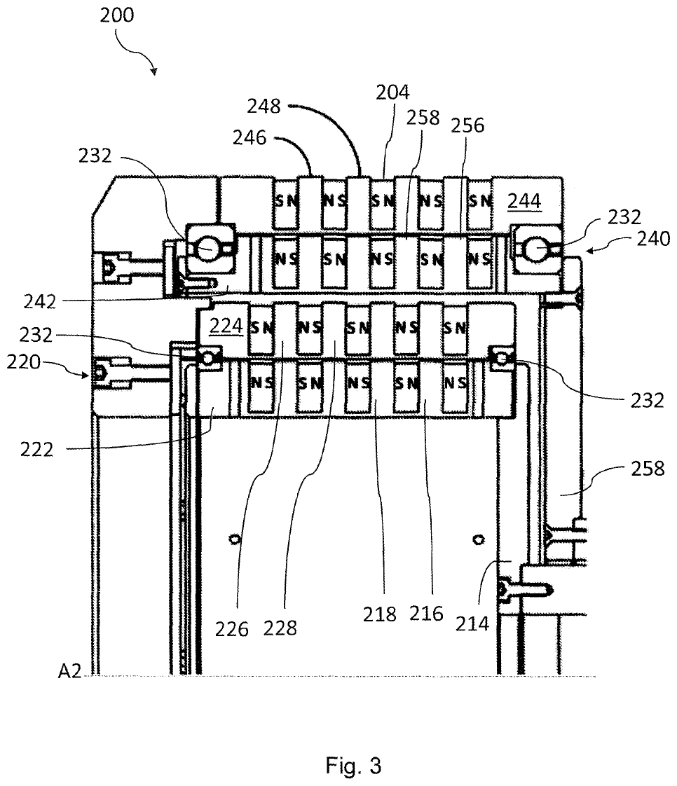

FIG. 3 shows a magnetic biasing arrangement 200 in cross section. The magnetic biasing assembly is substantially formed from two magnetic biasing assemblies: a first, inner magnetic biasing assembly 220 and a second, outer magnetic biasing assembly 240.

The first, inner magnetic biasing assembly 220 is formed from an outer element 224 and an inner element 220, which are connected via bearings 232 such that they can rotate relative to each other. The outer element 224 is held stationary and the inner element 222 is rotatable relative to the outer element 224. The inner element 222 can output torque via the support plate 214, which is connected to the pulley 24.

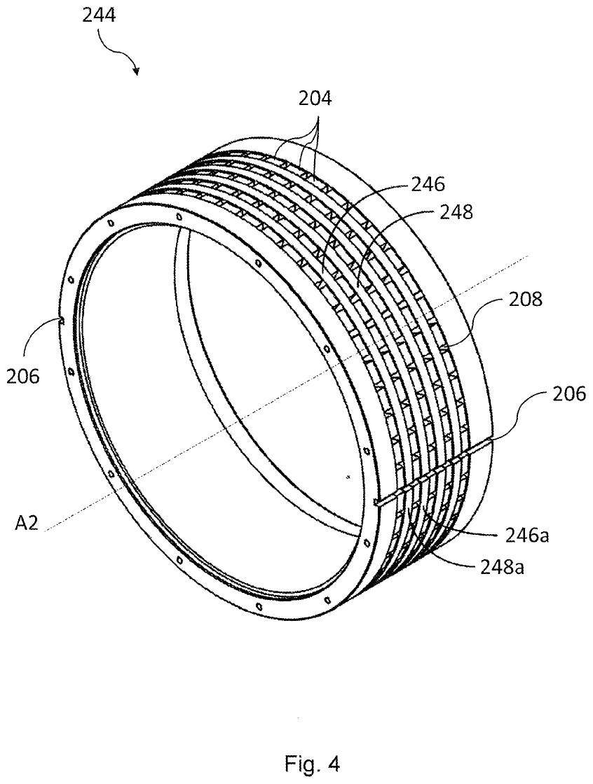

The inner element 222 of FIG. 3, which is substantially similar to the element 244 shown in FIG. 4, is formed of steel, but may be formed of other ferrous materials including soft iron. The inner element 222 has a plurality of polarised arcs 216, 218, which are polarised by magnets 204. The polarities of the magnets are indicated on the drawing, showing that arc 218 is a south polarised arc, being polarised by the magnets 204 either side of the arc and arc 216 is a north polarised arc, also being polarised by the magnets either side of the arc. In the arrangement shown, the inner element 222 has five polarised arcs 216, 218, polarised by five magnets 204. The labelled polarised arcs 216 and 218 are adjacent arcs and, since the arcs are substantially parallel and are separated by a distance along the axis A2 of the magnetic biasing assembly 220, about which the inner element 222 is rotatable, the arcs 216, 218 are referred to as being axially adjacent.

Between the axially adjacent polarised arcs 216, 218 are circumferential recesses 208, shown in FIG. 4, in which the magnets 204 are located. By locating the magnets 204 in recesses 208, the magnets 204 and polarised arcs 216, 218 can have a flux return path which is via an air gap between the inner and outer elements and which results in a higher torque being generated between the inner element 222 and outer element 224 when the elements are displaced from an equilibrium position.

The outer element 224 may be substantially similar to the inner element 222, with the exception that the polarities of the magnets 204 are reversed. The outer element 224 comprises a north polarised arc 226 and a south polarised arc 228, separated by a recess 208 containing a magnet 204. It can be seen from FIG. 3 that, when the magnetic biasing assembly 220 is in the equilibrium position, the north polarised arc 226 of the outer element is radially adjacent a south polarised arc 218 of the inner element and the south polarised arc of the outer element 224 is radially adjacent the north polarised arc 216 of the inner element 222.

Within the magnetic biasing arrangement 200, there is also an outer magnetic biasing assembly 240, which is separated from the inner magnetic biasing assembly 220 by an air gap larger than the air gap between the inner element 222 and outer element 224 and larger than the air gap between the inner element 242 and outer element 244 of the outer magnetic biasing assembly 240.

The magnetic biasing assembly 240 comprises an outer element 244 and an inner element 242, coupled via bearings 232 such that the inner element 242 can rotate relative to the outer element 244. In the arrangement shown in FIG. 3, the outer element 244 is held stationary and the inner element 242 is rotatable and may transfer torque to the first member 14 via support plate 258.

Similarly to the inner magnetic biasing assembly 220, the inner element 242 of the outer magnetic biasing assembly 240 has south polarised arcs 258 axially adjacent to north polarised arcs 256, the arcs being separated by a recess 208 containing magnets 204, the magnets polarising the respective polarised arcs 256, 258. Overall, the inner elements 222, 242 may be rotors and the outer elements 224, 244 may be stators.

The outer element 244 of the outer magnetic biasing assembly 240 is shown in a perspective view in FIG. 4. While only the outer element 244 is shown in FIG. 4, it will be understood that each of the other elements of the magnetic biasing arrangement 200 may have substantially similar arrangements and comprise similar features.

FIG. 4 shows the outer element 244, which comprises two sets of circumferential polarised arcs. The first north polarised arc 246 is coplanar in a plane normal to the axis A2 with second south polarised arc 248a and first south polarised arc 248 is coplanar in a plane normal to the axis A2 of the assembly with second north polarised arc 246a. The respective first and second polarised arcs are separated via a channel 206 formed in the outer surface of the element 244. The channel 206 of inner elements 222, 242 may be used to move magnets along and into the recesses 208 when the inner element is arranged circumferentially within an outer element and may also serve to increase magnetic reluctance in order to reduce magnetic flux leakage between coplanar north and south polarised arcs.

Put another way, one set of polarised arcs may extend around the element from 0° to 180°, and another set, having opposite polarity may extend around the element from 181° to 360°.

While the outer element 244 of FIG. 4 is shown as having 24 magnets 204 equally distributed across each semi-circular arc, it will be understood that different numbers of magnets may be used. The spacing of the magnet 204 is also shown as being regular, however, different spacings of magnets may be used in order to vary the magnetic field strength at different positions along the polarised arcs. For example, as few as ten magnets 204 may be used for a semi-circular arc.

The magnets 204 shown are rectangular bar magnets, but arcuate magnets 204 may also be used, with each magnet being of uniform magnetic field strength and direction. The magnetic field strength and direction. The magnetic field being oriented along an axis of the arc of the magnets.

The first polarised arcs 246, 428 are connected to the second arcs 246a, 248a, via a web, which remains after the channel 206 has been cut away. This web may be thinner than the arcs in order to increase the magnetic reluctance across the channel 206 and the web may also comprise voids, such as holes through the thickness of the web (the voids are not shown) in order to further increase the magnetic reluctance across the channel 206.

While the magnets 204 in the recesses 208 are shown as being axially aligned in FIG. 4, the magnets 204 in different recesses 208 may be offset, such as in a checkerboard pattern, or a helical pattern. This can reduce the overall cogging effect in the resulting assembly.

While the element shown has two arcs, each being substantially semi-circular, more arcs may be used. For example, elements having three arcs, each arc extending over approximately 120° may be used. It will be understood that both elements in a magnetic biasing assembly should preferably have the same number of arcs per element.

The element shown in FIG. 4 is annular. However, arrangements are possible in which the elements might not be complete annuli. For example, an element having an arcuate shape are possible.

The recesses 208 shown have sides which are flat and radial. However, the recesses 208 may be tapered so that the recess is narrower at a larger radius. This may help in manufacture as it can assist in keeping the magnets 204 in place and preventing the magnets 204 from leaving the recess. Therefore, a recess having a trapezoidal profile is possible, with the narrower side of the trapezoid being at an opening of the recess.

The elements may also be covered with a non-ferrous cover in order to keep the magnets in place and/or to protect the magnets. During or after manufacture, the magnets may be held in place by a tape, a band, or a thread.

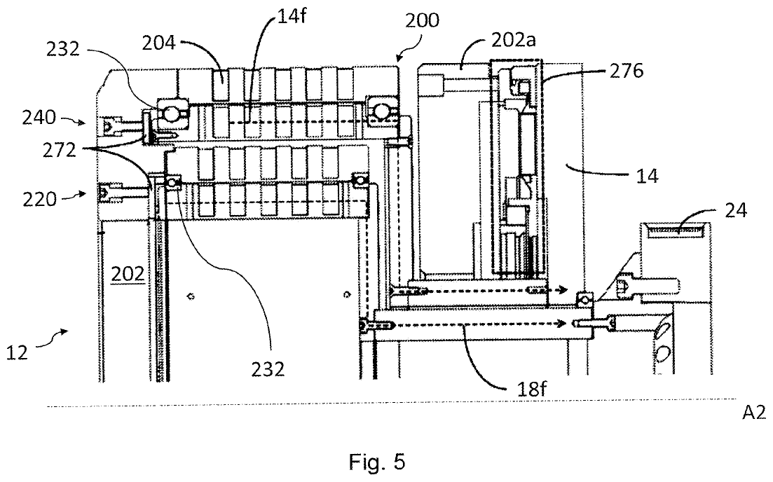

FIG. 5 shows the magnetic biasing arrangement 200 situated within the first joint 12 of the robotic arm 100.

In FIG. 5, there is shown the torque path 14f by which torque is transferred from the inner element of the outer magnetic biasing assembly 240 to the first member 14 and the torque path 18f by which torque is transferred from the inner element of the inner biasing assembly 220 to the first pulley 24 and thereby to the second member 18, via torque path 18f.

Also shown are friction inducing elements 272, which have the form of annular rings arranged to press against the inner elements of the respective magnetic biasing assemblies in order to exert a frictional torque on them in order to resist movement of the respective first and second members 14, 18.

There is also an actuator 276 arranged to exert a torque on the first member 14 selectively in order to move the first member 14. The actuator 276 is coupled to a support plate 202a and there is also a support plate 202 arranged to hold the outer elements of the respective inner and outer biasing assemblies 220, 240, stationary.

An electric motor may be situated in a space radially inside the inner element of the inner magnetic biasing assembly 220. The arrangement with the support plate 202 allows a hollow space to be formed and this hollow space may have a low magnetic flux. Therefore, an electric motor can be placed here, such as to drive the pulley 24 and thereby operate the second member 18 selectively. This can provide a self-contained a low-profile actuation assembly in the base 12 of a robotic arm, thereby reducing the weight of the members 14, 18 of the arm.

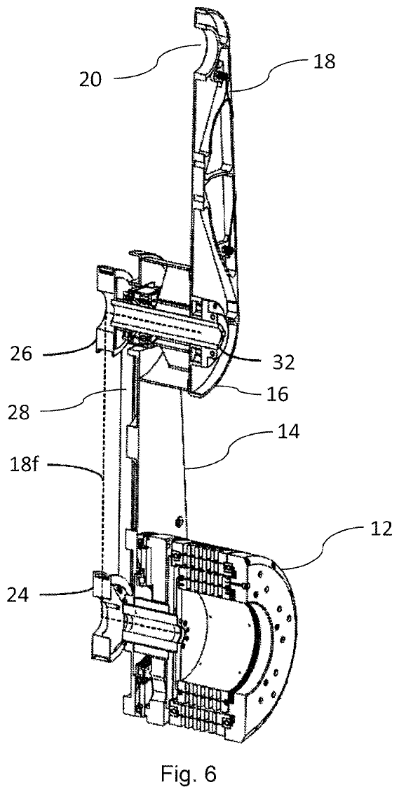

FIG. 6 shows a more complete torque path 18f from the first pulley 24, via the band 28, to the second pulley 26 and via a shaft 32, through the second joint 16 to the second member 18. It can therefore be seen how the movement about the second joint 16 due to the weight of the second member 18 may be reacted by the base 12 directly, as opposed to being reacted by the first member.

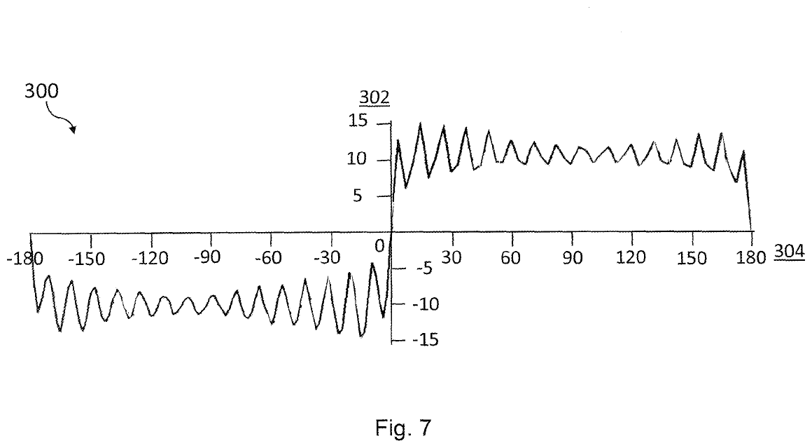

Lastly, FIG. 7 shows a torque profile 300 which can be produced by the magnetic biasing assemblies shown in FIGS. 3 to 5. This graph shows torque on the Y axis 302, measured in Newton metres, against rotational displacement from equilibrium on the X axis 304, measured in degrees. It can be seen that the torque profile is a substantially square wave and that therefore the magnetic biasing assembly exerts a consistent torque on the arms towards an equilibrium position, thereby helping to balance the members to which they are connected.

In an alternative embodiment, a magnetic biasing assembly may comprise multiple polarised arcs which are not coterminous or there may be provided a magnetic biasing arrangement having multiple axially adjacent magnetic biasing assemblies which are differently oriented about their axis. By using this arrangement, the substantially square-wave magnetic torque profiles of each set of arcs or each magnetic biasing assembly may be combined in order to provide a greater range of magnetic torque profiles, including a sine-wave shaped profile.

A magnetic biasing arrangement according to the invention may be manufactured by a particularly convenient method. The recesses of an outer element of the assembly may be populated with magnets. If the recesses are trapezoidal, the magnets may be introduced via an axial channel and side into the recesses in a circumferential direction. Alternatively, if the channels have parallel sides, the magnets may be kept in place by a tape or thread.

A recess of an inner element of the magnetic biasing assembly may also, separately, be partially populated with magnets by having a plurality of magnets inserted into the recess. This insertion of the magnets may be substantially similar to the insertion of magnets into the recess of the outer element.

The inner element may then be inserted into the outer element so that it lies circumferentially inside the outer element. This step may be easier if the inner element comprises fewer magnets since the magnetic forces between the inner and outer elements can hinder axial alignment of the elements.

Following the insertion of the inner element within the outer element, a further set of magnets may be inserted into the inner element to further populate the recesses of the inner element. An axial channel of the inner element in communication with the circumferential recess of the inner element may be used in order to provide space to move the magnets between the inner and outer elements and into the correct position within an outer circumferential recess of the inner element.

Further, the shape of the elements may allow convenient manufacture as the elements may be formed from annular preforms having constant cross-sections and may then undergo material removal processes in order to form circumferential recesses and/or axial channels.

1. A magnetic biasing assembly comprising:
an inner element comprising:
a north polarised inner arc, and
a south polarised inner arc disposed axially adjacent to the north polarised inner arc, and
an outer element arranged to rotate relative to the inner element about an axis, the inner and outer elements being substantially concentric, the outer element comprising:
a north polarised outer arc, and
a south polarised outer arc disposed axially adjacent to the north polarised outer arc,
wherein the inner and outer polarised arcs are arranged so as to have a stable equilibrium position and are arranged to exert a magnetic moment between the inner and outer elements in a direction towards the stable equilibrium position when the inner and outer elements are not in the stable equilibrium position.

2. The magnetic biasing assembly of claim 1, wherein the inner element further comprises:
a second north polarised inner arc arranged to be substantially coplanar with the south polarised inner arc in a plane normal to the axis, and
a second south polarised inner arc disposed axially adjacent to the second north polarised inner arc and substantially coplanar with the north polarised inner arc in a plane normal to the axis, and
wherein the outer element further comprises:
a second north polarised outer arc arranged to be substantially coplanar with the south polarised outer arc in a plane normal to the axis, and
a second south polarised outer arc disposed axially adjacent to the second north polarised outer arc and substantially coplanar with the north polarised outer arc in a plane normal to the axis.

3. The magnetic biasing assembly of claim 2, wherein the coplanar inner and outer polarised arcs are separated by a gap having a higher magnetic reluctance than the arcs.

4. The magnetic biasing assembly of claim 3, further comprising:
a plurality of permanent magnets arranged to polarise the north polarised arc and the south polarised arc of each pair of axially adjacent arcs.

5. The magnetic biasing assembly of claim 4, wherein the plurality of magnets are arranged between the north polarised arc and the south polarised arc of each pair of axially adjacent arcs.

6. The magnetic biasing assembly of claim 4, wherein the magnets of the plurality of magnets are bar magnets.

7. The magnetic biasing assembly of claim 6, wherein the inner and outer elements each contain 3 or more bar magnets, and
wherein adjacent bar magnets are separated by a central angle of less than 36° measured at the axis.

8. The magnetic biasing assembly of claim 4, wherein the polarised arcs have the form of ridges and are separated by arcuate recesses, the recesses containing the magnets.

9. The magnetic biasing assembly of claim 8, wherein the arcuate recesses are on the outer side of the respective elements.

10. The magnetic biasing assembly of claim 2, wherein each arc has a central angle of at least 120° and the equilibrium position is where the inner and outer arcs are coterminous.

11. The magnetic biasing assembly of claim 10, wherein the arcs are connected via a web extending across the gap, the web having a thickness less than the thickness of the arcs.

12. The magnetic biasing assembly of claim 11, wherein the web comprises at least one void.

13. The magnetic biasing assembly of claim 1, further comprising a friction inducing element arranged to exert a frictional moment between the inner and outer elements.

14. The magnetic biasing assembly of claim 1, further comprising at least one electrical coil arranged to generate a magnetic field when an electrical current travels through the electrical coil, and
wherein the electrical coil allows adjustment of the strength of the magnetic moment.

15. A magnetic biasing arrangement comprising two magnetic biasing assemblies of claim 1, wherein the magnetic biasing assemblies are arranged concentrically.

16. A robot arm comprising:
a base;
a first member connected to the base via a first joint and pivotable relative to the base;
a second member connected to the first member via a second joint and pivotable relative to the first member; and
the magnetic biasing assembly of claim 1, arranged to exert a torque on the second member about the second joint to move the second member relative to the first member,
wherein the magnetic biasing assembly is connected to the base so that the torque exerted on the second member is opposed by the base directly.

17. The robot arm of claim 16, wherein the magnetic biasing assembly is arranged at the first joint.

18. The robot arm of claim 16, wherein the magnetic biasing assembly is coupled to the second member via a pulley and cable system.

18-22. (canceled)

23. A robot arm comprising:
a base;
a first member connected to the base via a first joint and pivotable relative to the base;
a second member connected to the first member via a second joint and pivotable relative to the first member; and
the magnetic biasing arrangement of claim 15,
wherein a first of the magnetic biasing assemblies is arranged to impart a torque to the second member about the second joint to move the second member relative to the first member, the torque from the first magnetic biasing assembly being opposed by the base directly, and
wherein a second of the magnetic biasing assemblies is arranged to impart a torque to the first member about the first joint to move the first member relative to the base, the torque from the second magnetic biasing assembly being opposed by the base directly.

24. A method of manufacturing a magnetic biasing assembly comprising the following steps in the following order:
inserting a first plurality of magnets into a circumferential recess of a first annular member;
arranging the first annular member concentrically within a second annular member; and
inserting a second plurality of magnets into the circumferential recess.

25. The method of claim 24, further comprising forming the circumferential recess by a material removal process.

26. The method of claim 24, wherein the first annular member is formed from an annular preform having a constant cross-section.

27. The method of claim 24, wherein the second annular member further comprises an axial channel on an outer surface, and
wherein the second plurality of magnets are inserted via the channel.
